(19) United States
(12) Patent Application Publication
(10) Pub. No.: US 2026/0299954 A1
(43) Pub. Date: Oct. 1, 2026

(54) DATA PROCESSING APPARATUS AND METHOD

(71) Applicant: Smarter Silicon (Shanghai) Technologies Co., Ltd., Shanghai (CN)

(72) Inventors: Xutao ZHANG, Shanghai (CN); Liang DAI, Shanghai (CN)

(21) Appl. No.: 19/633,458

(22) Filed: Mar. 30, 2026

(30) Foreign Application Priority Data
Mar. 31, 2025 (CN) 202510401643.5

(51) Int. Cl. G06F 9/38; G06F 9/30

(52) U.S. Cl. CPC G06F 9/3802; G06F 9/30181

(57) ABSTRACT

A data processing apparatus includes a control module and an encoding module. The control module is configured to generate a control signal. The control signal is used to determine whether to perform a split processing or a merge processing on to-be-processed data. The encoding module is connected to the control module and is configured to receive the to-be-processed data and the control signal, convert the to-be-processed data into a plurality of compressed slices for caching, perform a data fetch operation on cached data on a per-cycle basis according to the control signal, and output a result of the data fetch operation.

### CROSS-REFERENCES TO RELATED APPLICATION

The present disclosure claims priority to Chinese Patent Application No. 202510401643.5, filed on Mar. 31, 2025, the entire content of which is incorporated herein by reference.

### FIELD OF TECHNOLOGY

The present disclosure relates to the field of display processing technology and, more particularly, to a data processing apparatus and method.

### BACKGROUND

A post-processing module (outctrl) of a digital signal processing chip (DSP) performs integration or division of multi-channel data through Merge or Split functions to address bandwidth bottleneck issues in high-resolution display scenarios.

However, whether in a data merge process of a Merge module or a data split process of a Split module, long-duration data buffering is required. Thus, the complexity of timing control is significantly increased. Therefore, optimizing the delay caused by merging or splitting becomes a challenge for the post-processing of the digital signal processing chip.

### SUMMARY

One aspect of this disclosure provides a data processing apparatus, including a control module and an encoding module. The control module is configured to generate a control signal. The control signal is used to determine whether to perform a split processing or a merge processing on to-be-processed data. The encoding module is connected to the control module and is configured to receive the to-be-processed data and the control signal, convert the to-be-processed data into a plurality of compressed slices for caching, perform a data fetch operation on cached data on a per-cycle basis according to the control signal, and output a result of the data fetch operation.

Another aspect of this disclosure provides a data processing method. The method includes obtaining to-be-processed data and a control signal, converting the to-be-processed data into a plurality of compressed slices for caching, performing a data fetch operation on cached data on a per-cycle basis based on the control signal, and outputting a result of the data fetch operation. The control signal is used to determine whether to perform split processing or merge processing on the to-be-processed data. The control signal includes a merge control signal and a split control signal. In response to the merge control signal being in an enabled state, the data fetch operation is performed once per cycle, and data is fetched from cached data of the plurality of compressed slices each time the data fetch operation is performed, or, in response to the split control signal being in an enabled state, the data fetch operation is performed multiple times in parallel per cycle, and data is fetched from cached data of a corresponding portion of compressed slices of the plurality of compressed slices each time the data fetch operation is performed.

Another aspect of this disclosure provides a computer-readable storage medium storing a program that, when executed by one or more processors, causes the one or more processors to generate a control signal, receive the to-be-processed data and the control signal, convert the to-be-processed data into a plurality of compressed slices for caching, perform a data fetch operation on cached data on a per-cycle basis according to the control signal, and output a result of the data fetch operation. The control signal is used to determine whether to perform a split processing or a merge processing on to-be-processed data.

### BRIEF DESCRIPTION OF THE DRAWINGS

Through the description of embodiments of the present disclosure with reference to the accompanying drawings, the above and other purposes, features, and advantages of the present disclosure are clearer.

FIG. 1 is a schematic structural diagram of a DSP chip of the existing technology according to some embodiments of the present disclosure.

FIG. 2 is a schematic structural diagram of a data processing apparatus according to some embodiments of the present disclosure.

FIG. 3 is a schematic diagram of a data stream of a fusion processing of to-be-processed data according to some embodiments of the present disclosure.

FIG. 4 is a schematic diagram of a data stream of a splitting processing of to-be-processed data according to some embodiments of the present disclosure.

FIG. 5 is a schematic structural diagram of a data processing apparatus according to some embodiments of the present disclosure.

FIG. 6 is a schematic structural diagram of an input port according to some embodiments of the present disclosure.

FIG. 7 is a schematic structural diagram of an input unit according to some embodiments of the present disclosure.

FIG. 8 is a schematic structural diagram of an input unit according to some embodiments of the present disclosure.

FIG. 9 is a schematic structural diagram of a sliced data path according to some embodiments of the present disclosure.

FIG. 10 is a schematic structural diagram of an output unit according to some embodiments of the present disclosure.

FIG. 11 is a schematic diagram of a data stream of an output unit according to some embodiments of the present disclosure.

FIG. 12 is a schematic structural diagram of an output unit according to some embodiments of the present disclosure.

FIG. 13 is a schematic diagram of a data stream of an output unit according to some embodiments of the present disclosure.

FIG. 14 is a schematic diagram of a data stream of an output unit according to some embodiments of the present disclosure.

FIG. 15 is a schematic diagram of a data stream of an output unit according to some embodiments of the present disclosure.

FIG. 16 is a schematic structural diagram of a data processing apparatus according to some embodiments of the present disclosure.

FIG. 17 is a schematic diagram of a data fusion method according to some embodiments of the present disclosure.

FIG. 18 is a schematic diagram of a data fusion method according to some embodiments of the present disclosure.

FIG. 19 is a schematic diagram of a data fusion method according to some embodiments of the present disclosure.

### DETAILED DESCRIPTION

To make the objectives, technical solutions, and advantages of the present disclosure clearer, the technical solutions of the present disclosure are further described in detail below in conjunction with the accompanying drawings and embodiments. The described embodiments should not be construed as limiting the present disclosure. All other embodiments obtained by those of ordinary skill in the art without creative effort shall fall within the scope of the present disclosure.

In the following description, “some embodiments” describe a subset of all possible embodiments. However, “some embodiments” may be the same subset or different subsets of all possible embodiments, and may be combined with one another without conflict.

If expressions such as “first/second” appear in the present disclosure, the following explanation is added. In the following description, the terms “first/second/third” are used merely to distinguish similar objects and do not represent any specific ordering of the objects. Where permitted, “first/second/third” may be interchanged in a specific order or sequence, so that embodiments of the present disclosure described here may be implemented in an order other than that illustrated or described here.

Unless otherwise defined, all technical and scientific terms used here have the same meanings as those commonly understood by those skilled in the art. The terminology used here is for the purpose of describing embodiments of the present disclosure only and is not intended to limit the present disclosure.

FIG. 1 is a schematic structural diagram of a digital signal processing chip (DSP) 200 of the existing technology according to some embodiments of the present disclosure. FIG. 1 only illustrates a first channel (Channel) 210 and a second channel 220. The digital signal processing chip (DSP) 200 can further include a larger number of channels, which is not limited here. Each channel includes a data conversion module (Data Convert), a data split module (Split), a merge module (Merge), an encoder (DSC_ENC), a buffer module, and a frame timing module (Frame Timing).

As shown in FIG. 1, data conversion modules 211 and 221 are configured to maintain signal integrity in scenarios such as audio processing and wireless communications. For example, the data conversion modules 211 and 221 can convert analog signals into digital signals. Merge modules 212 and 222 are configured to perform data merge operations. That is, a plurality of sub-streams or processing results of different channels can be integrated into a single data stream to ensure timing and logical consistency. Split modules 213 and 223 are configured to divide a continuous data stream or a high-bandwidth signal into a plurality of sub-streams according to specific rules (such as frequency bands or time slices) to facilitate parallel processing or multi-channel data transmission. Encoders 214a,214b, 224a, and 224b are configured to compress and encode video or image data to reduce transmission bandwidth requirements while maintaining visual quality. For example, the encoders can employ predictive coding and transform-domain quantization to reduce redundant data. Buffer modules 215 and 225 are configured to buffer the data compressed by the encoders. Frame timing modules 216a, 216b, 226a, and 226b are configured to manage timing synchronization and alignment of data frames to ensure clock consistency and data integrity of transmitting and receiving ends. For example, the frame timing modules can use phase-locked loops (PLLs) to generate stable clock signals and eliminate phase offsets caused by transmission delays.

As shown in FIG. 1, during the data merge process, data of the first channel 210 and the second channel 220 are merged by the merge module 212a of the first channel 210, and then input to an input port of the encoder 214a of the first channel 210. Then, after being compressed by the encoder 214a, the data are output after passing through the buffer module 215 and the frame timing module 216a. That is, the to-be-processed data is merged by the merge module and then transmitted to the encoder for compression.

As shown in FIG. 1, during the process of splitting the to-be-processed data, the to-be-processed data is input to the split module 213 after passing through the data conversion unit 211 to split the to-be-processed data. Then, the split module 213 inputs the split data to the encoders 214a and 214b of the first channel 220 for compression, and the compressed data is stored in the buffer module 215. Thereafter, to ensure the interval of the output time of the split data remains within an allowable range, after the frame timing modules 216a and 216c generate corresponding timing, the data buffered in the buffer module 215 can be output. For example, when the to-be-processed data is image data, the ports receiving the split data can be MIPI DSI (Display Serial Interface) interfaces. Data skew can allow a slight timing difference between two signals, and the frame timing modules 216a and 216c may need to ensure that the two outputs complete adjacent line transmission within a horizontal front porch (HFP) cycle of the display. That is, in the prior art, the to-be-processed data can be split by the split module. The split data can be transmitted to the encoder for compression after the split processing. Meanwhile, in the existing technology, the frame timing module and the buffer module need to be provided to ensure that a plurality of pieces of data after the split processing are output synchronously.

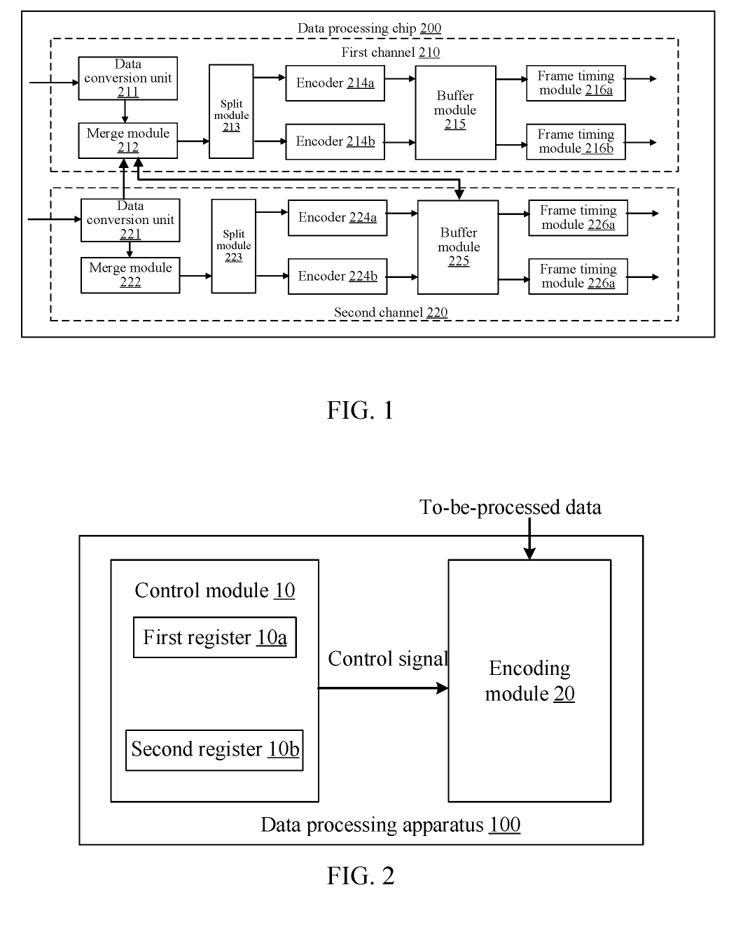

FIG. 2 is a schematic structural diagram of a data processing apparatus 100 according to some embodiments of the present disclosure. As shown in FIG. 2, a control module 10 is arranged at an advanced peripheral bus (APB) or in other devices, which is not limited here.

In embodiments of the present disclosure, as shown in FIG. 2, the data processing apparatus 100 includes a control module 10. The control module 10 is configured to generate a control signal. The control signal is used to determine whether to perform the split process or the merge process on the to-be-processed data. The control module 10 includes a first register 10a and a second register 10b. The first register 10a can be configured to generate a merge control signal in an enabled state when the to-be-processed data is subjected to the merge process. The second register 10b can be configured to generate a split control signal in an enabled state when the to-be-processed data is subjected to the split process.

In embodiments of the present disclosure, as shown in FIG. 2, the control signal is generated by encoding. For example, when the merge control signal is in an enabled state, the level of the merge control signal can be 1. Conversely, when the merge control signal is in a disabled state, the level of the merge control signal can be 0. When the split control signal is in an enabled state, the level of the split control signal can be 1. Conversely, when the split control signal is in a disabled state, the level of the split control signal can be 0.

In embodiments of the present disclosure, as shown in FIG. 2, the data processing apparatus 100 includes an encoding module 20. The encoding module can be an encoder. The encoder can encode the to-be-processed data based on display stream compression (DSC) technology. The encoding module 20 can be configured to convert the to-be-processed data into a plurality of compressed slices. For example, the encoding module 20 can use the encoder to divide the received to-be-processed data into a plurality of compression slices. Thereafter, the encoding module 20 can compress the plurality of decomposed slices using algorithms such as residual quantization, indexed color history (ICH), and entropy coding (VLC) to generate the plurality of compressed slices. The data volume of each slice can be smaller than the data volume of the to-be-processed data. The data volume of the compressed slice after compression can be smaller than the data volume of the corresponding slice.

In embodiments of the present disclosure, as shown in FIG. 2, the encoding module 20 buffers a plurality of compressed slices, and performs a data-fetch operation on the buffered data cyclically based on the control signal and output the result of the data-fetch operation. For example, when the merge control signal is in the enabled state, the encoding module 20 can perform the data-fetch operation on the plurality of compressed slices in each cycle of the data-fetch operation. Then, after the data-fetch operations of a plurality of cycles, the plurality of compressed slices can be merged into a data-fetch operation result. For another example, when the split control signal is in the enabled state, the encoding module 20 can perform parallel data-fetch operations multiple times on the plurality of compressed slices in each cycle of the data-fetch operation. Then, after the data-fetch operations of the plurality of cycles, the plurality of compressed slices can be split into a plurality of data-fetch operation results. The number of parallel data-fetch operations can be equal to the predetermined split number of the to-be-processed data. For example, if the to-be-processed data needs to be split into 2, the number of the parallel data-fetch operations can be 2, and the number of the results of the data-fetch operations can be 2. That is, the encoding module 20 can implement the split process and the merge process of the to-be-processed data when the data-fetch operation is performed on the plurality of compressed slices.

The encoding module 20 can be configured to perform the split process and the merge process on the plurality of compressed slices by controlling the method of data-fetch operations in each cycle. Then, compared with the existing technology, in embodiments of the present disclosure, no additional split module and merge module are needed for performing the split process and the merge process. Thus, the chip area can be further reduced, the energy consumption can be lowered, and the integration degree of the chip can be increased. Meanwhile, in embodiments of the present disclosure, the delay caused by the split process and the merge process in the existing technology can be avoided. Therefore, the delay in the processing process of the to-be-processed data can be reduced to further improve the data processing speed.

In some embodiments of the present disclosure, as shown in FIG. 2, the encoding module 20 is configured to perform the data-fetch operation one time in each cycle when the merge control signal is in the enabled state. In each data-fetch operation, the data can be fetched from the buffered data in a plurality of compressed slices.

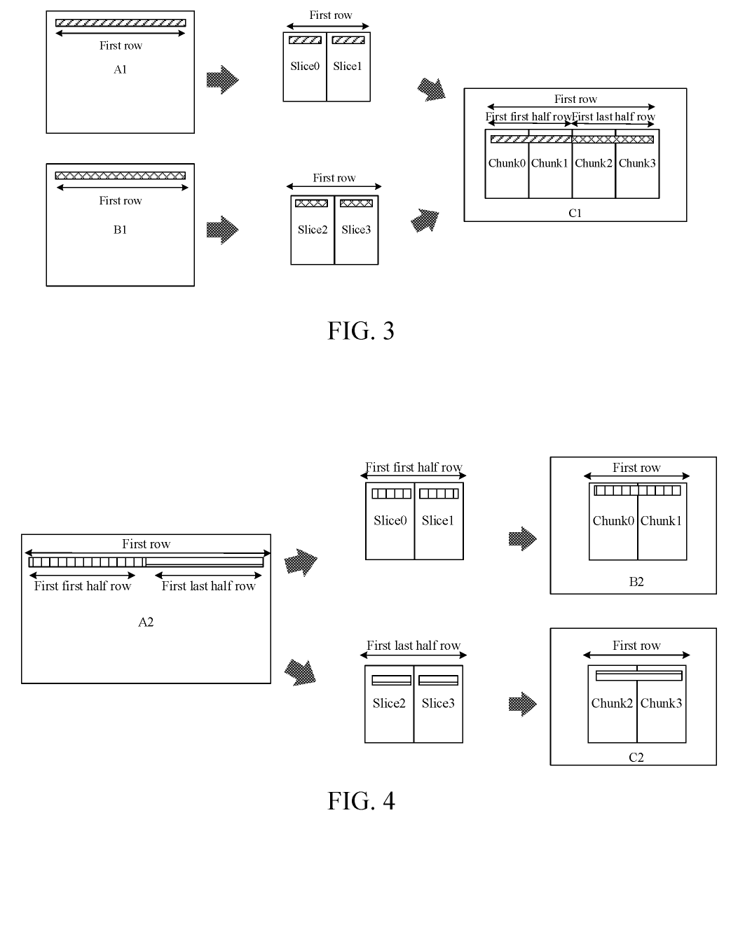

FIG. 3 is a schematic diagram of a data stream of a merge process of to-be-processed data according to some embodiments of the present disclosure. The encoding module 20 is configured to perform the merge process on the to-be-processed data. The to-be-processed data shown in FIG. 3 includes two pieces of sub-data, i.e., image A1 and image B1. After being compressed, image A1 and image B1 are merged to generate image C1. That is, image C1 is a data-fetch operation result after image A1 and image B1 are merged. The to-be-processed data can also be other types of data and include a greater number of pieces of sub-data, which are not limited here.

In embodiments of the present disclosure, as shown in FIGS. 2 and 3, the encoding module 20 is able to convert the to-be-processed data into a plurality of compressed slices. For example, when the merge control signal is in the enabled state, the encoding module 20 is configured to split image A1 into two slices, slice0 and slice1, and split image B1 into two slices, slice2 and slice3. Then, the encoding module 20 is configured to compress slice0, slice1, slice2, and slice3 to generate four corresponding compressed slices. The four compressed slices are buffered.

Further, under the control of the merge control signal, the encoding module 20 can perform the data-fetch operations on the plurality of compressed slices in each cycle to generate a data-fetch operation result. For example, as shown in FIG. 3, each data-fetch operation of the encoding module 20 generates a row of data of image C1. In the process of generating the first row data of image C1, the first row data of image A1 is evenly split in slice0 and slice1, and the first row data of image B1 is evenly split in slice2 and slice3. Then, the encoding module 20 can be configured to sequentially perform the data-fetch operations on the compressed slices corresponding to the four slices of slice0, slice1, slice2, and slice3 according to a chunk size in the first cycle to obtain four chunks of chunk0, chunk1, chunk2, and chunk3. The data in chunk0 and chunk1 can be the first row data of the compressed image A1, and the data in chunk2 and chunk3 can be the first row data of compressed image B1. Then, the encoding module 20 can be configured to sequentially concatenate chunk0, chunk1, chunk2, and chunk3. The data of chunk0 and chunk1 after concatenation can merge into the first half of the first row of image C1, and data of chunk2 and chunk3 after concatenation can merge into the last half of the first row of image C1. The data-fetch operations for the remaining rows of image C1 can be performed according to the method of the first row. Thus, the encoding module 20 can be configured to perform the merge process on the plurality of compressed slices through the data-fetch operations of the plurality of cycles. Then, compressed image A1 and compressed image B1 can be merged into image C1.

In some other embodiments of the present disclosure, as shown in FIG. 2, the encoding module 20 is configured to perform a plurality of data-fetch operations in parallel in each cycle when the split control signal is in the enabled state. Then, each data-fetch operation can fetch cached data of some compressed slices corresponding to the plurality of compressed slices.

FIG. 4 is a schematic diagram of a data stream of the split process of the to-be-processed data according to some embodiments of the present disclosure. The encoding module 20 is configured to perform the split process on the to-be-processed data. The to-be-processed data of FIG. 4 includes image A2. Image B2 and image C2 are data-fetch results by splitting image A2. Image A2 can also be split into a larger number of images, which is not limited here.

In embodiments of the present disclosure, as shown in FIGS. 2 and 4, the encoding module 20 is configured to convert the to-be-processed data into a plurality of compressed slices. For example, when the split control signal is in the enabled state, the encoding module 20 is configured to split image A2 into four slices, slice0, slice1, slice2, and slice3. Then, the encoding module 20 is configured to compress slice0, slice1, slice2, and slice3 to generate four corresponding compressed slices and buffer the compressed slices.

Further, under the control of the split control signal, the encoding module 20 is configured to perform parallel data-fetch operations on the plurality of compressed slices according to cycles to generate a plurality of data-fetch operation results. For example, as shown in FIG. 4, slice0, slice1, slice2, and slice3 are data obtained by decomposing image A2. The first half of the first row of image A2 is evenly distributed in slice0 and slice1, and the last half of the first row of image A2 is evenly distributed in slice2 and slice3. In the process of generating the first row data of image B2, the encoding module 20 is configured to perform a data-fetch operation on two slices of slice0 and slice 1 in sequence according to the chunk size to obtain two chunks of chunk0 and chunk1. Then, the encoding module 20 is further configured to concatenate chunk0 and chunk1 to form the first row of image B2. In the process of generating the first row of image C2, in the first cycle, the encoding module 20 is configured to sequentially perform data-fetch operations, according to the chunk size, on the compressed slices corresponding to slice2 and slice3 to obtain two chunks of chunk2 and chunk3. Then, the encoding module 20 is configured to concatenate chunk2 and chunk3 to form the first row of image C2. The data-fetch operations for the remaining rows of image B2 and image C2 can be understood by reference to the process for the first row, which is not repeated here. Thus, through the parallel data-fetch operations of a plurality of cycles, the encoding module 20 is able to split the plurality of compressed slices to split compressed image A2 into image B2 and image C2.

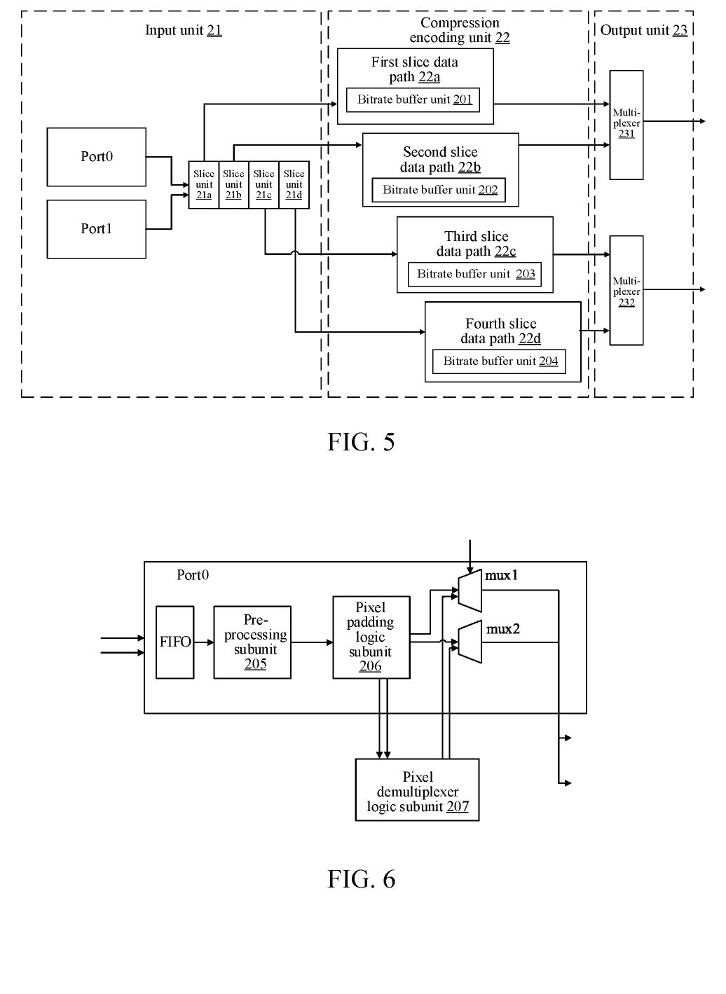

FIG. 5 is a schematic structural diagram of the encoding module 20 according to some embodiments of the present disclosure. The encoding module 20 shown in FIG. 5 includes an input unit 21, a compression encoding unit 22, and an output unit 23. The input unit 21 is configured to receive to-be-processed data and decompose the to-be-processed data into a plurality of slices. The compression encoding unit 22 is configured to compress the slices into the compressed slices and buffer the compressed slices. The output unit 23 is configured to perform the data-fetch operations on the buffered compressed slices, and package and output the results of the data-fetch operations.

FIG. 6 is a schematic structural diagram of an input port Port0 in FIG. 5 according to an embodiment of the present disclosure. The remaining input ports, such as input port Port1 in FIG. 5, are able to be understood with reference to the input port Port0 shown in FIG. 6, which is not repeated here.

In embodiments of the present disclosure, as shown in FIG. 6, the input port Port0 includes a pre-processing subunit (Pre logic) 205, a pixel padding logic subunit 206, and a pixel demultiplexer logic subunit 207. When the to-be-processed data is image data, the pre-processing subunit 205 is configured to perform pre-processing such as format conversion and color space adjustment on the input pixel data. For example, original image data can be converted into a format required for DSC encoding, such as an RGB format converted into a YUV format, and a data bit width can be ensured to meet the input requirements of subsequent compression algorithms. The pixel padding logic subunit 206 is configured to fill the pixels of the input image to satisfy the boundary alignment requirements of block-based compression. When the original resolution cannot be evenly divided by the minimum processing block of the compression algorithm (such as a macroblock), the image size can be expanded by padding the redundant pixels to ensure the integrity of subsequent block processing. The pixel demultiplexer logic subunit 207 is configured to assign or reorganize the input pixel data stream into a plurality of paths. For example, according to different color channels or parallel processing requirements, serial input data can be demultiplexed into a plurality of parallel data paths through selectors mux1 and mux2 to adapt to a multi-channel processing architecture within the encoder. A first input first output (FIFO) is used to ensure that the data processing order is consistent with the input order.

As shown in FIG. 5, the input unit 21 includes two input ports, Port0 and Port1, and four slice units 21a, 21b, 21c, and 21d. The encoding module 20 can also include other numbers of input ports, and each input port can also include other numbers of slice units, which is not limited here. When no control signal is received, each input port in the encoding module 20 can be independently configured. For example, slice units 21a and 21b are allocated to input port Port0, and slice units 21a and 21b only decompose data received by input port Port0. The multiplexer 231 is allocated to input port Port0, and the multiplexer 231 only performs data-fetch operations on compressed slices buffered in the first slice data path 22a and the second slice data path 22b. Slice units 21c and 21d are allocated to input port Port1, and slice units 21c and 21d only decompose data received by input port Port1. The multiplexer 231 is allocated to input port Port1, and the multiplexer 231 only performs data-fetch operations on compressed slices buffered in the third slice data path 22c and the fourth slice data path 22d.

In some embodiments of the present disclosure, as shown in FIG. 5, the input unit 21 is configured, when the merge control signal is in an enabled state, to select a plurality of input ports from all input ports of the input unit 21 to receive a plurality of pieces of sub-data of the to-be-processed data, respectively, and decompose the corresponding received sub-data by the slice units connected to each input port.

In embodiments of the present disclosure, as shown in FIG. 5, when the merge control signal is in the enabled state, the input unit 21 is configured to select the plurality of input ports from all input ports of the input unit 21 to receive the plurality of pieces of sub-data of the to-be-processed data, respectively. For example, the to-be-processed data includes image A1 and image B1 shown in FIG. 3. Then, the input unit can select two input ports to receive image A1 and image B1. Input port Port0 is configured to receive image A1 shown in FIG. 3, and slice units 21a and 21b allocated to input port Port0 are configured to decompose image A1 to generate slice0 and slice1 shown in FIG. 3. Input port Port1 is configured to receive image B1 shown in FIG. 3, and slice units 21c and 21d allocated to input port Port1 are configured to decompose image B1 to generate slice2 and slice3 shown in FIG. 3.

In some embodiments of the present disclosure, as shown in FIG. 5, the output unit 23 is configured, when the merge control signal is in the enabled state, to select any one of all slice multiplexers of the output unit 23 to perform the data-fetch operations. The results of the data-fetch operations are output by the output port connected to the slice multiplexer.

In embodiments of the present disclosure, as shown in FIG. 5, when the merge control signal is in the enabled state, the output unit 23 is configured to select any one of all slice multiplexers of the output unit 23 to perform data-fetch operations. For example, the to-be-processed data are decomposed into four slices slice0, slice1, slice2, and slice3 as shown in FIG. 3. The compressed slices obtained after compressing slice0, slice1, slice2, and slice3 are respectively buffered in the first slice data path 22a, the second slice data path 22b, the third slice data path 22c, and the fourth slice data path 22d in a one-to-one correspondence. The control module 10 is configured to output the merge control signal to the slice multiplexer 231. Then, under the control of the merge control signal, the slice multiplexer 231 is configured to perform data-fetch operations on cached data of the plurality of compressed slices. The slice multiplexer 231 is configured to perform data-fetch operations on the first slice data path 22a and the second slice data path 22b to generate chunk0 and chunk1 as shown in FIG. 3. The slice multiplexer 231 is configured to perform data-fetch operations on the third slice data path 22c and the fourth slice data path 22d to generate chunk2 and chunk3 as shown in FIG. 3. Thereafter, the slice multiplexer 231 is further configured to concatenate chunk0, chunk1, chunk2, and chunk3. That is, the first row of image A1 and the first row of image B1 are merged into the first row of image C1. Then, the slice multiplexer 231 is configured to generate image C1 through a plurality of data-fetch operations and output image C1 from the output port of the slice multiplexer 231. That is, compared with the independent configuration of input ports in the existing technology, in embodiments of the present disclosure, the slice multiplexer 231 can be controlled by the merge control signal to perform the data-fetch operations on the compressed slices from other input ports to realize the merge process of a plurality of compressed slices during the data-fetch operation process.

In some other embodiments of the present disclosure, as shown in FIG. 5, when the split control signal is in the enabled state, any one input port is selected from all input ports of the input unit 21 to receive the to-be-processed data, and a plurality of slice units are selected from all slice units of the input unit 21 to decompose the to-be-processed data.

In embodiments of the present disclosure, as shown in FIG. 5, when the split control signal is in the enabled state, the input unit 21 is configured to select any one input port from all input ports of the input unit 21 to receive the to-be-processed data. For example, the input unit 21 is configured to receive image A2 shown in FIG. 4 through input port Port0.

In embodiments of the present disclosure, as shown in FIG. 5, when the split control signal is in the enabled state, the input unit 21 is configured to select a plurality of slice units from all slice units of the input unit 21 to decompose the to-be-processed data. That is, after receiving the split control signal, the input unit 21 is able to flexibly call the slice units allocated to the plurality of input ports. For example, input port Port0 is configured to receive image A2 shown in FIG. 4, while input port Port1 does not receive data and is in an idle state. Moreover, slice units 21c and 21d allocated to input port Port1 are also in an idle state. Under the control of the split control signal, the input unit 21 is configured to call slice units 21c and 21d allocated to input port Port1 to decompose the to-be-processed data. Slice units 21a and 21b allocated to input port Port0, as well as slice units 21c and 21d allocated to input port Port1, are configured to decompose image A2 to generate four slices slice0, slice1, slice2, and slice3 as shown in FIG. 4. That is, compared with the independent configuration of input ports in the existing technology, in embodiments of the present disclosure, the to-be-processed data can be decomposed by calling the slice units of other idle input ports. Thus, in embodiments of the present disclosure, the decomposing speed of the to-be-processed data can be improved by increasing the number of slice units configured to decompose the to-be-processed data to further improve the data processing efficiency.

In some other embodiments of the present disclosure, as shown in FIG. 5, the output unit 23 is configured, when the split control signal is in the enabled state, to select a plurality of slice multiplexers from all slice multiplexers of the output unit 23 to perform data-fetch operations in parallel, and output the results of the data-fetch operations in parallel through a plurality of output ports connected to the slice multiplexers.

In embodiments of the present disclosure, as shown in FIG. 5, the output unit 23 is configured to select the plurality of slice multiplexers from all slice multiplexers of the output unit 23 to perform the data-fetch operations in parallel. The output terminals of the slice multiplexers are the output ports of the output unit 23. For example, image A2 shown in FIG. 4 needs to be split into image B2 and image C2. The output unit 23 needs to select two slice multiplexers to perform data-fetch operations. The to-be-processed data is decomposed into four slices slice0, slice1, slice2, and slice3 as shown in FIG. 4, and the compressed slices obtained after compressing slice0, slice1, slice2, and slice3 are cached in the first slice data path 22a, the second slice data path 22b, the third slice data path 22c, and the fourth slice data path 22d, respectively. The control module 10 can output the split control signals to slice multiplexer 231 and slice multiplexer 232. Then, under the control of the split control signal, slice multiplexer 231 and slice multiplexer 232 perform the data-fetch operations in parallel on cached data of the plurality of compressed slices.

Slice multiplexer 231 can be configured to perform the data-fetch operations on the compressed slices cached in the first slice data path 22a and the second slice data path 22b to obtain two data-fetch chunks chunk0 and chunk1, and concatenate chunk0 and chunk1 to form the first row of image B2. Slice multiplexer 232 can be configured to perform the data-fetch operations on the compressed slices cached in the third slice data path 22c and the fourth slice data path 22d to obtain two data-fetch chunks chunk2 and chunk3, and concatenate chunk2 and chunk3 to form the first row of image C2. Then, slice multiplexer 231 can be configured to generate image B2 through the plurality of data-fetch operations based on the split control signal and output image B2 from the output port of the slice multiplexer 231. Slice multiplexer 232 can be configured to generate image C2 through the plurality of data-fetch operations and output image C2 from the output port of slice multiplexer 232. That is, in embodiments of the present disclosure, the plurality of slice multiplexers can perform the data-fetch operations in parallel based on the control of the same split control signal. Then, in embodiments of the present disclosure, the results of the plurality of data-fetch operations can be synchronously output after the split process. Meanwhile, in embodiments of the present disclosure, the plurality of pieces of data can be ensured to be output synchronously after the split process without providing the frame control unit to further improve chip integration and reduce energy consumption.

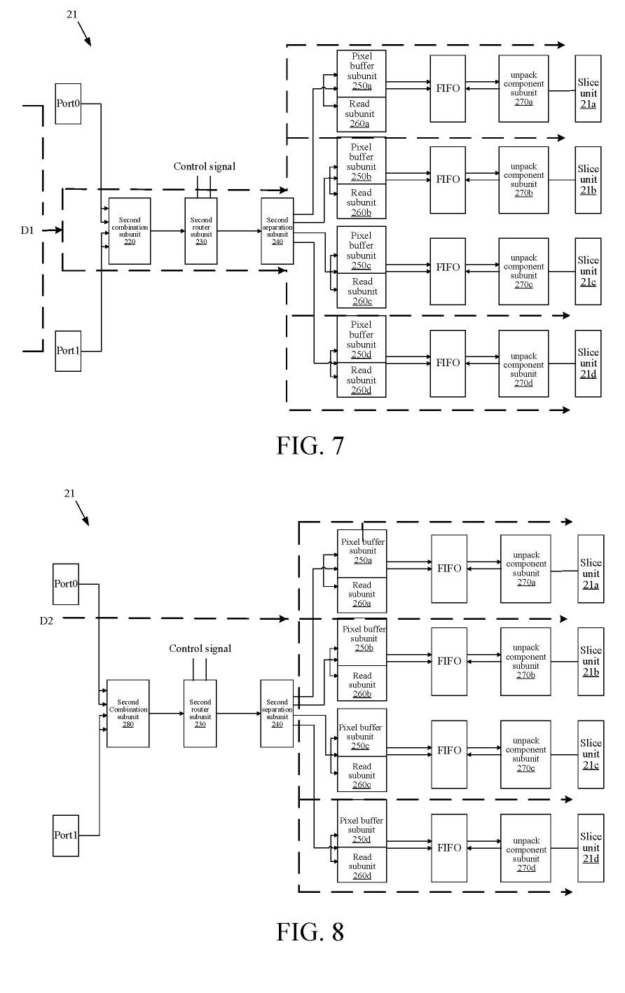

FIG. 7 is a schematic structural diagram of an optional input unit 21 provided by an embodiment of the present disclosure. FIG. 7 more specifically illustrates a data flow when the control signal is a merge control signal. As shown in FIG. 7, the input unit 21 includes a second combination logic subunit 220, a second router logic subunit (X-BAR Logic) 230, a second separation logic subunit 240, pixel buffer subunits 250a, 250b, 250c, and 250d, read request logic subunits 260a, 260b, 260c, and 260d, and unpack component logic subunits 270a, 270b, 270c, and 270d. The second combination logic subunit 220 is configured to receive a plurality of slices and merge arrays corresponding to the plurality of slices to generate a multidimensional array. The second separation logic subunit 240 is configured to receive a one-dimensional array converted from the multidimensional array and transmit pixel data in the one-dimensional array to corresponding slice data paths in the encoding compression unit. The read request logic is configured to receive the one-dimensional data after converting the multi-dimensional data and transmit the pixel data of the one-dimensional data to the slice data path corresponding to the encoding compression unit. The read request logic units 260a, 260b, 260c, and 260d are configured to receive a read request signal and read the data from the slice unit based on the read request signal. The pixel buffer subunits 250a, 250b, 250c, and 250d are configured to receive and buffer the read pixel data. The unpack component logic subunits 270a, 270b, 270c, and 270d are configured to extract the parameter components of the pixel data. A FIFO (First In First Out) is used to ensure that the processing order of data is consistent with the input order.

In some embodiments of the present disclosure, as shown in FIG. 7, the second router logic subunit 230 is connected to the control module 10 and all input ports. For example, as shown in FIG. 7, the second router logic subunit 230 is connected to input port Port0 and input port Port1. The second router logic subunit 230 can receive the control signal output by the control module.

In embodiments of the present disclosure, as shown in FIG. 7, the second router logic subunit 230 is configured, when the merge control signal is in the enabled state, to transmit sub-data received by each input port to slice units connected to the corresponding input ports. For example, when the merge control signal is in the enabled state, the two pieces of sub-data of the to-be-processed data are transmitted to the second router subunit 230 along the input port Port0 and input port Port1 according to the method shown in D1 of FIG. 7. The second router subunit 230 is configured to transmit the data received by input port Port0 to slice units 21a and 21b. The second router subunit 230 is configured to transmit the data received by the input port Port1 to slice units 21c and 21d.

FIG. 8 is a schematic structural diagram of an input unit 21 according to some embodiments of the present disclosure. FIG. 8 specifically illustrates the data stream of the control signal as a split control signal. The devices in FIG. 8 can be understood with reference to FIG. 7, which is not repeated here.

In some other embodiments of the present disclosure, as shown in FIG. 8, when the split control signal is in the enabled state, the second router subunit 230 is configured to transmit the to-be-processed data to a plurality of slice units selected by the split control signal. For example, when the split control signal is in the enabled state, the to-be-processed data is input to the second router subunit 230 via the input port Port0 in the method illustrated by D2 in FIG. 8. Thereafter, the second router subunit 230 is configured to transmit the data received from the input port Port0 to the slice units 21a and 21b, and 21c and 21d. Thus, in embodiments of the present disclosure, the decomposing speed of the to-be-processed data can be increased by increasing the number of the slice units for decomposing the to-be-processed units to further improve the data processing efficiency.

In some embodiments of the present disclosure, as shown in FIG. 5, the encoding and compression unit 22 is connected to the input unit 21 and the output unit 23. The data of the plurality of compressed slices is buffered through a plurality of bitrate buffer units in the encoding and compression unit 22. For example, a compressed slice is generated after slice0 is compressed through the first slice data path 22a. The compressed slice corresponding to slice0 is stored in the bitrate buffer unit 201.

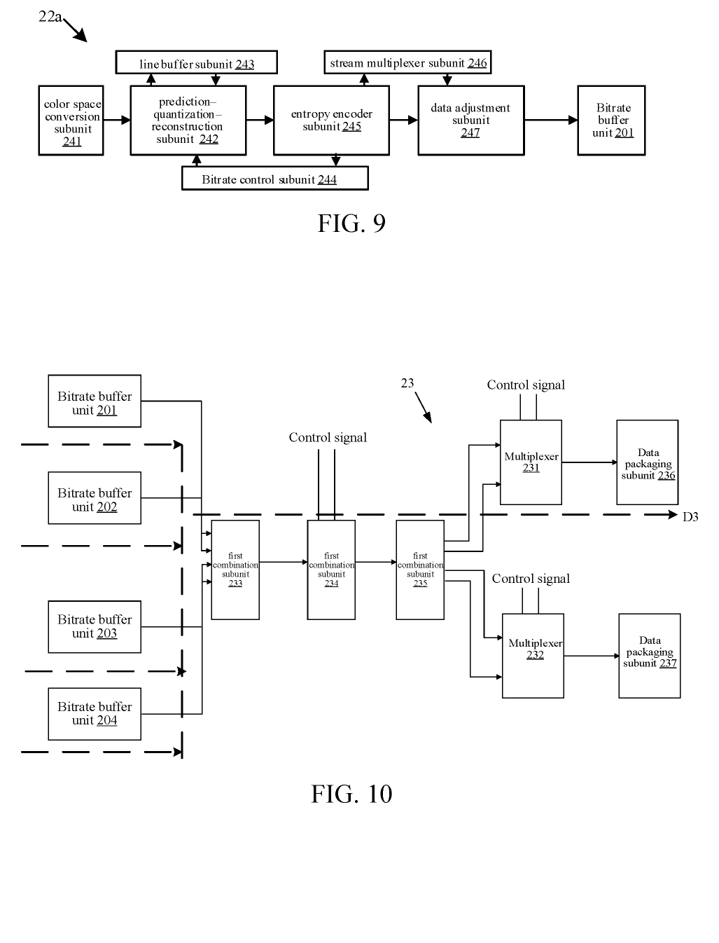

FIG. 9 is a schematic structural diagram of a sliced data path according to some embodiments of the present disclosure. FIG. 9 specifically illustrates the first slice data path 22a in FIG. 5. The remaining slice data paths in FIG. 5 are understood with reference to the first slice data path 22a shown in FIG. 9, which is not repeated here.

In embodiments of the present disclosure, as shown in FIGS. 5 and 9, the encoding and compression unit 22 is configured to convert the data received by each slice unit into a corresponding compressed slice. For example, the first slice data path 22a includes a color space conversion subunit 241, a prediction–quantization–reconstruction subunit 242, a line buffer subunit 243, a rate control subunit 244, an entropy encoder subunit 245, a sub-stream multiplexer subunit 246, and a data adjustment subunit 247. The color space conversion subunit 241 is configured to receive the corresponding slice0 and perform format conversion on slice0. The prediction–quantization–reconstruction subunit 242 is connected to the color space conversion subunit 241 and is configured to calculate reconstructed values of pixel data in slice0. The line buffer subunit 243 is connected to the prediction–quantization–reconstruction subunit 242 and is configured to receive and buffer the reconstructed values. The entropy encoder subunit 245 is connected to the prediction–quantization–reconstruction subunit 242 and is configured to encode slice0 to generate the compressed slice. The rate control subunit 244 is connected to the entropy encoder subunit 245 and the prediction–quantization–reconstruction subunit 242, and is configured to control the output bitrate of the compressed slice. The data adjustment subunit 247 is connected to the entropy encoder subunit 245 and the sub-stream multiplexer subunit 246, and is configured to adjust the size of the compressed slice. The sub-stream multiplexer subunit 246 is configured to multiplex a plurality of sub-streams in the compressed slice into one data packet.

FIG. 10 is a schematic structural diagram of an output unit 23 according to some embodiments of the present disclosure. FIG. 10 more specifically illustrates a data flow after the output unit 23 receives a merge control signal. The output unit 23 of FIG. 10 includes a first combination subunit 233, a first separation subunit 235, and data packaging subunits 236 and 237. The first combination subunit 233 is configured to receive a plurality of compressed slices and convert the plurality of compressed slices into a three-dimensional array. The first separation subunit 235 is configured to receive a request signal and, based on the request signal, perform data fetching on a one-dimensional array converted from the compressed slices. The data packaging subunits 236 and 237 are configured to receive the results of the data fetch operations and package and output the results of the data fetch operations.

In some embodiments of the present disclosure, as shown in FIG. 10, the first router subunit 234 is configured to, when the merge control signal is in the enabled state, transmit the data of the plurality of buffered compressed slices to any slice multiplexer selected by the merge control signal.

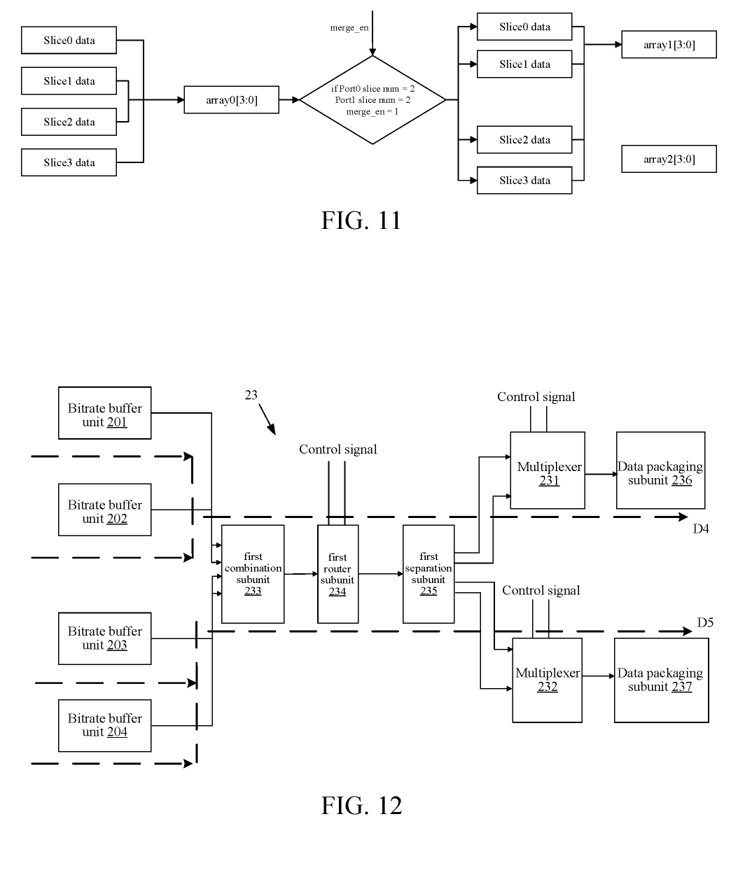

FIG. 11 is a schematic diagram of a data stream of the transmission data of the first router subunit 234 according to some embodiments of the present disclosure. “Slice0 data” is the compressed slice buffered in the bitrate buffer unit 201 in FIG. 10, “Slice1 data” is the compressed slice buffered in the bitrate buffer unit 202 in FIG. 10, “Slice2 data” is the compressed slice buffered in the bitrate buffer unit 203 in FIG. 10, and “Slice3 data” is the compressed slice buffered in the bitrate buffer unit 204 in FIG. 10.

In embodiments of the present disclosure, as shown in FIGS. 10 and 11, when the merge control signal is in the enabled state, the plurality of compressed slices converted from the to-be-processed data are input to the first combination subunit 233 via the bitrate buffer units 201, 202, 203, and 204 in the manner illustrated by D3 in FIG. 10. Thereafter, as shown in FIG. 11, the first combination subunit 233 is configured to convert the compressed slices in the bitrate buffer units 201, 202, 203, and 204 into a three-dimensional array array0[3:0], and transmit the three-dimensional array array0[3:0] to the first router subunit 234.

Further, the first router subunit 234 can be configured to convert the received three-dimensional array array0[3:0] into a corresponding number of one-dimensional arrays according to the number of slice units allocated to each input port and the enabled state of the control signal. For example, as shown in FIG. 11, input port Port0 and input port Port1 each include two slice units, and the control signal is a merge control signal in the enabled state. Then, the first router subunit 234 is configured to convert the received three-dimensional array array0[3:0] into a one-dimensional array array1[3:0], and then transmit the one-dimensional array array1[3:0] to the first separation subunit 235. After receiving the merge control signal in the enabled state, the multiplexer 231 is configured to send a request signal to the first separation subunit 235, and then the first separation subunit 235 is configured to transmit the one-dimensional array array1[3:0] to the multiplexer 231. Thus, compared with the independent configuration of input ports, in embodiments of the present disclosure, the first router subunit 234 can be controlled by the merge control signal to merge the plurality of compressed slices from different input ports.

FIG. 12 is a schematic structural diagram of an output unit 23 according to some embodiments of the present disclosure. FIG. 12 more specifically illustrates a data flow when the control signal is a split control signal. The devices in FIG. 12 are understood with reference to FIG. 10, which are not repeated here.

In some other embodiments of the present disclosure, as shown in FIG. 12, the first router subunit 234 is configured to, when the split control signal is in the enabled state, transmit the data of the plurality of buffered compressed slices to the plurality of slice multiplexers selected by the split control signal, respectively.

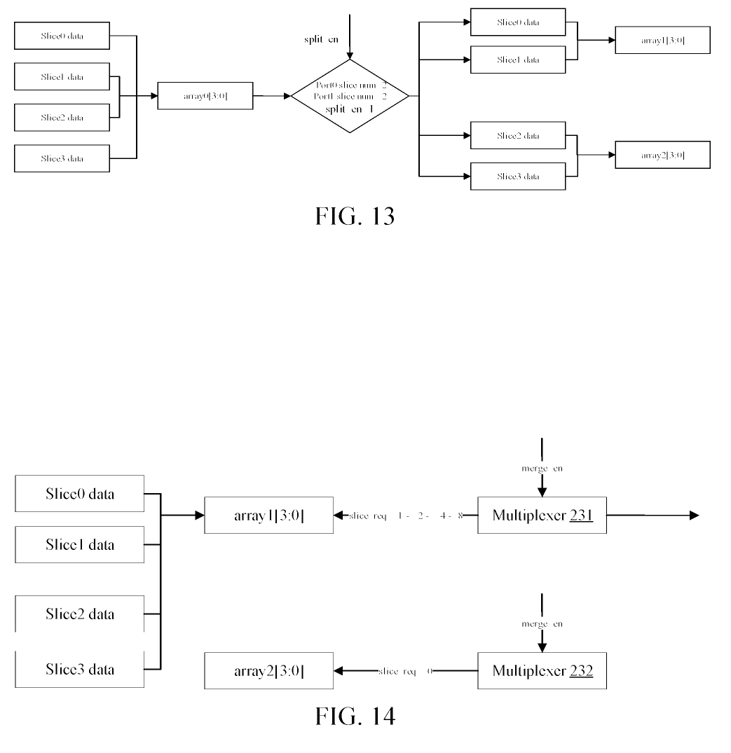

FIG. 13 is a schematic diagram of a data stream of the transmission data of the first router subunit 234 according to some embodiments of the present disclosure. “Slice0 data” is the compressed slice buffered in the bitrate buffer unit 201 in FIG. 12, “Slice1 data” is the compressed slice buffered in the bitrate buffer unit 202 in FIG. 12, “Slice2 data” is the compressed slice buffered in the bitrate buffer unit 203 in FIG. 12, and “Slice3 data” is the compressed slice buffered in the bitrate buffer unit 204 in FIG. 12.

In embodiments of the present disclosure, as shown in FIGS. 12 and 13, when the split control signal is in the enabled state, a portion of the plurality of compressed slices is input to the first combination subunit 233 via the bitrate buffer units 201 and 202 in the manner illustrated by D4 in FIG. 11. Some compressed slices of the plurality of compressed slices are input to the first combination subunit 233 via the bitrate buffer units 203 and 204 in the manner illustrated by D5 in FIG. 11, and some other compressed slices of the plurality of compressed slices are input to the first combination subunit 233 via the bitrate buffer units 203 and 204. Then, as shown in FIG. 13, the first combination subunit 233 is configured to convert the compressed slices of the bitrate buffer units 201, 202, 203, and 204 into the three-dimensional array array0[3:0], and transmit the three-dimensional array array0[3:0] to the first router subunit 234.

Further, the first router subunit 234 can be configured to convert the received three-dimensional array array0[3:0] into a corresponding number of one-dimensional arrays according to the number of slice units allocated to each input port and the enabled state of the control signal. For example, as shown in FIG. 13, input port Port0 and input port Port1 each include two slice units, and the control signal is a split control signal in the enabled state. Then, the first router subunit 234 is configured to convert the received three-dimensional array array0[3:0] into two one-dimensional arrays array1[3:0] and array2[3:0], and then transmit the one-dimensional arrays array1[3:0] and array2[3:0] to the first separation subunit 235. After receiving the merge control signal in the enabled state, multiplexers 231 and 232 are configured to send request signals to the first separation subunit 235, and then the first separation subunit 235 is configured to transmit the one-dimensional array array1[3:0] to the multiplexer 231 and transmit the one-dimensional array array2[3:0] to the multiplexer 232.

That is, in embodiments of the present disclosure, the plurality of slice multiplexers can be configured to transmit the results of the data fetch operations based on the same first router subunit 234, and the transmission process of the first router subunit 234 can be controlled by the split control signal. Thus, in embodiments of the present disclosure, the data fetch operations can be synchronously performed in parallel by the first router subunit 234. Then, in embodiments of the present disclosure, the parallel data fetch operations in each cycle can be ensured to remain synchronous to synchronously output the results of the plurality of data fetch operations after the split process.

In some embodiments of the present disclosure, each slice multiplexer can be configured to receive a control signal, generate a request signal, and adjust an assignment value of the request signal based on the control signal. The assignment value of the request signal can be used to select, from the plurality of compressed slices, the compressed slice corresponding to each data fetch operation.

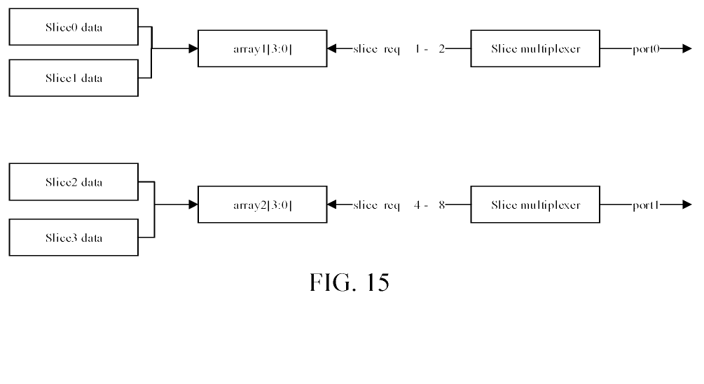

FIGS. 14 and 15 show data flows of data fetch operations performed by optional slice multiplexers according to embodiments of the present disclosure. FIG. 14 specifically illustrates a data flow when the control signal is a merge control signal, and FIG. 15 specifically illustrates a data flow when the control signal is a split control signal.

In embodiments of the present disclosure, as shown in FIGS. 10 and 14, when the merge control signal is in the enabled state, the multiplexer 231 is configured to generate a request signal slice_req, and perform data fetching on the one-dimensional array array1[3:0] based on the generated request signal slice_req. For example, the request signal slice_req can be encoded by bitmask, and the binary assignment value of the request signal slice_req can directly map to the data block to be fetched in the current operation. As shown in FIG. 3, the data fetching process of the first row of image C1 includes concatenating four data blocks chunk0, chunk1, chunk2, and chunk3. The multiplexer 231 can be configured to first assign the request signal slice_req a value of 1, and fetch data from the one-dimensional array array1[3:0] to generate data fetch block chunk0. Thereafter, in the subsequent cycles, the multiplexer 231 can sequentially assign the request signal slice_req values of 2, 4, and 8, and fetch data from the one-dimensional array array1[3:0] to generate data fetch blocks chunk1, chunk2, and chunk3.

In embodiments of the present disclosure, as shown in FIGS. 12 and 15, when the split control signal is in the enabled state, the multiplexer 231 is configured to generate a request signal slice_req and perform data fetching on the one-dimensional array array1[3:0] based on the generated request signal slice_req. The multiplexer 232 can be configured to generate the request signal slice_req and perform data fetching on the one-dimensional array array2[3:0] based on the generated request signal slice_req. As shown in FIG. 4, the data fetching process of the first row of image B2 includes concatenating the two data fetch blocks chunk0 and chunk1. The data fetching process of the first row of image C2 includes concatenating the two data blocks chunk2 and chunk3. In the first cycle, the multiplexer 231 can first assign the request signal slice_req a value of 1, and perform data fetching on the one-dimensional array array1[3:0] to generate data fetch block chunk0. The multiplexer 232 can be configured to fetch data from the one-dimensional array array2[3:0] to generate data fetch block chunk1. Thereafter, in the next cycle, the multiplexer 231 can be configured to assign the request signal slice_req a value of 2, and fetch data from the one-dimensional array array1[3:0] to generate data fetch block chunk1. The multiplexer 232 can assign the request signal slice_req a value of 2, and fetch data from the one-dimensional array array2[3:0] to generate data fetch block chunk3.

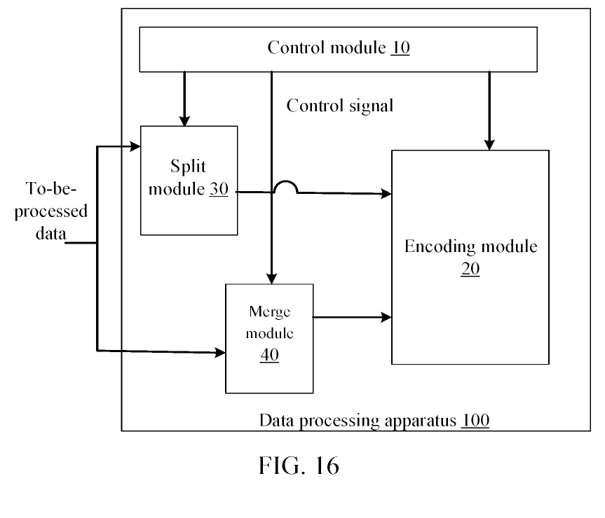

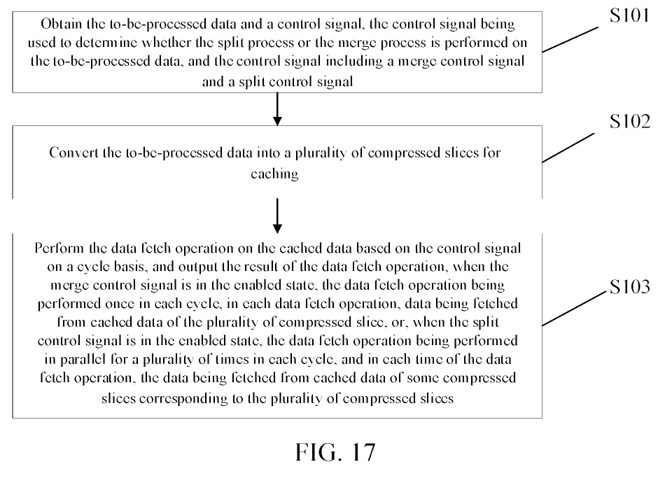

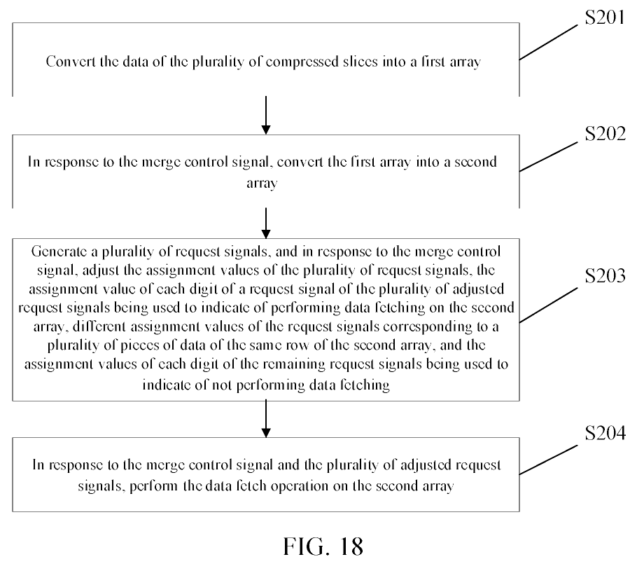

FIG. 16 is a schematic structural diagram of another data processing apparatus 100 according to embodiments of the present disclosure. As shown in FIG. 16, the data processing apparatus 100 further includes a split module 30 and a merge module 40. Both split module 30 and the merge module 40 are connected to the control module 10. An output end of the split module 30 and an output end of the merge module 40 are connected to the encoding module 20. Both the split module 30 and the merge module 40 can be provided with a dedicated bypass control circuit. After receiving a control signal, the split module 30 and the merge module 40 can enter a bypass mode. For example, the split module 30 can be configured to receive a split control signal generated by the control module 10 and send the received to-be-processed data to the control module 10 via the bypass when the split control signal is in the enabled state. The merge module 40 can be configured to receive a split control signal generated by the control module 10 and transmit the received to-be-processed data to the control module via the bypass when the merge control signal is in the enabled state. That is, in bypass mode, the split module 30 and the merge module 40 can be configured to transmit the received to-be-processed data through a backup channel. Thus, in embodiments of the present disclosure, delays caused by the split or merge process can be avoided to reduce latency in the data processing procedure and further improve data processing speed.

FIG. 17 is a schematic flowchart of a data processing method according to embodiments of the present disclosure. As shown in FIG. 17, the data processing method is implemented using the data processing apparatus 100 shown in FIGS. 2 or 10, which is described in detail in steps.

At S101, the to-be-processed data and a control signal are obtained. The control signal is used to determine whether the split process or the merge process is performed on the to-be-processed data. The control signal includes a merge control signal and a split control signal.

At S102, the to-be-processed data is converted into a plurality of compressed slices for caching.

At S103, the data fetch operation is performed on the cached data based on the control signal on a cycle basis, and the result of the data fetch operation is output. When the merge control signal is in the enabled state, the data fetch operation is performed once in each cycle. In each data fetch operation, data is fetched from the cached data of the plurality of compressed slices. Alternatively, when the split control signal is in the enabled state, the data fetch operation is performed in parallel for a plurality of times in each cycle. In each data fetch operation, the data is fetched from the cached data of some compressed slices corresponding to the plurality of compressed slices.

In embodiments of the present disclosure, as shown in FIG. 2, when the merge control signal is in the enabled state, the encoding module 20 is configured to perform the data fetch operation on the plurality of compressed slices in each cycle of the data fetch operation. Then, after the data fetch operations of the plurality of cycles, the plurality of compressed slices can be merged as a result of the data fetch operation. That is, the encoding module 20 is configured to perform the merge process on a plurality of pieces of sub-data of the to-be-processed data based on the merge control signal.

In embodiments of the present disclosure, as shown in FIG. 2, when the split control signal is in the enabled state, the encoding module 20 is configured to perform a plurality of parallel data fetch operations on the plurality of compressed slices in each cycle and split the plurality of compressed slices into a plurality of results of the data fetch operations after the data fetch operations of a plurality of cycles. The number of parallel data fetch operations can be equal to a predetermined split number of the to-be-processed data. For example, if the to-be-processed data needs to be split into two pieces, the number of parallel data fetch operations can be 2, and the number of results of the data fetch operation can be 2. That is, the encoding module 20 can be configured to perform the split process on the to-be-processed data based on the control of the split control signal.

The encoding module can be configured to perform the split process and the merge process on the plurality of compressed slices by controlling the data fetch operations of each cycle. Then, in embodiments of the present disclosure, additional hardware, such as the split module and the merge module, may not need to be provided for the split process and the merge process. Thus, the chip area can be further reduced, and the integration level of the chip can be improved. Meanwhile, in embodiments of the present disclosure, the delay caused by the split process and the merge process of the existing technology can be avoided to reduce the latency in the data processing process for the to-be-processed data to further improve the data processing speed.

In some embodiments of the present disclosure, S103 in FIG. 17 is implemented by S201 to S204 shown in FIG. 18, which are described in detail below.

At S201, the data of the plurality of compressed slices is converted into a first array.

At S202, in response to the merge control signal, the first array is converted into a second array.

In embodiments of the present disclosure, as shown in FIGS. 10 and 11, when the merge control signal is in the enabled state, the plurality of compressed slices converted from the to-be-processed data are input to the first combination subunit 233 along the bitrate buffer units 201, 202, 203, and 204 as illustrated in D3 of FIG. 10. Then, as shown in FIG. 11, the first combination subunit 233 is configured to convert the compressed slices of the bitrate buffer units 201, 202, 203, and 204 into a three-dimensional array array0[3:0] (the first array) and transmit the three-dimensional array array0[3:0] to the first router subunit 234.

Further, the first router subunit 234 can be configured to convert the received three-dimensional array array0[3:0] into a corresponding number of one-dimensional arrays (the second array) according to the number of slice units allocated to each input port and the enabled state of the control signal. For example, as shown in FIG. 11, input ports Port0 and Port1 each include two slice units, and the control signal is a merge control signal in the enabled state. Then, the first router subunit 234 can be configured to convert the received three-dimensional array array0[3:0] into a one-dimensional array array1[3:0] and transmit the one-dimensional array array1[3:0] to the first separation subunit 235. After the multiplexer 231 receives the merge control signal in the enabled state, the multiplexer 231 can send a request signal to the first separation subunit 235, and then the first separation subunit 235 can transmit the one-dimensional array array1[3:0] (the second array) to the multiplexer 231.

At S203, a plurality of request signals are generated, and in response to the merge control signal, the assignment values of the plurality of request signals are adjusted. The assignment value of each digit of a request signal of the plurality of adjusted request signals is used to indicate performing data fetching on the second array, different assignment values of the request signals correspond to a plurality of pieces of data of the same row of the second array, and the assignment values of each digit of the remaining request signals are used to indicate of not performing data fetching.

At S204, in response to the merge control signal and the plurality of adjusted request signals, the data fetch operation is performed on the second array.

In embodiments of the present disclosure, as shown in FIGS. 10 and 14, when the merge control signal is in the enabled state, the multiplexer 231 is configured to generate the request signal slice_req and fetch data from the one-dimensional array array1[3:0] based on the generated request signal slice_req. For example, the request signal slice_req can be encoded by using a bitmask, and the binary assignment value of slice_req can directly map to the data fetch block that needs to be currently operated. As shown in FIG. 3, the data fetching process of the first row of image C1 includes concatenating four data fetching blocks chunk0, chunk1, chunk2, and chunk3. The multiplexer 231 can first assign the request signal slice_req a value of 1. The multiplexer 231 can fetch data from the one-dimensional array array1[3:0] to generate data fetch block chunk0. Then, in the following cycles, the multiplexer 231 can sequentially assign the request signal slice_req values of 2, 4, and 8, and fetch data from the one-dimensional array array1[3:0] to generate data fetch blocks chunk1, chunk2, and chunk3.

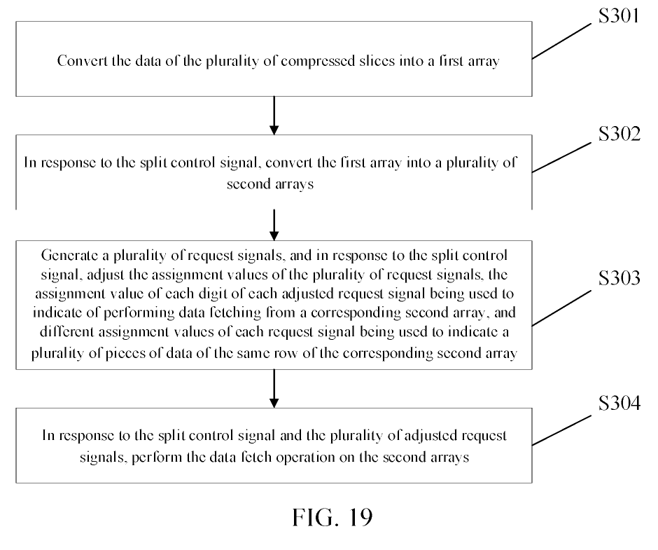

In some embodiments of the present disclosure, S103 in FIG. 17 is implemented by S301 to S304 shown in FIG. 19, which are described in detail below.

At S301, the data of the plurality of compressed slices is converted into a first array.

At S302, in response to the split control signal, the first array is converted into a plurality of second arrays.

At S303, a plurality of request signals are generated, and in response to the split control signal, the assignment values of the plurality of request signals are adjusted. The assignment value of each digit of each adjusted request signal is used to indicate performing data fetching from a corresponding second array. Different assignment values of each request signal are used to indicate a plurality of pieces of data of the same row of the corresponding second array.

At S304, in response to the split control signal and the plurality of adjusted request signals, the data fetch operation is performed on the second arrays.

In embodiments of the present disclosure, as shown in FIGS. 12 and 13, when the split control signal is in the enabled state, a portion of the plurality of compressed slices is input via bitrate buffer units 201 and 202 to the first combination subunit 233 in the manner illustrated by D4 in FIG. 11. Another portion of the plurality of compressed slices is input via bitrate buffer units 203 and 204 to the first combination subunit 233 in the manner illustrated by D4 and D5 in FIG. 11. Then, as shown in FIG. 13, the first combination subunit 233 is configured to convert the compressed slices from bitrate buffer units 201, 202, 203, and 204 into a three-dimensional array array0[3:0] (the first array) and transmit the three-dimensional array array0[3:0] to the first router subunit 234.

Further, the first router subunit 234 can be configured to convert the received three-dimensional array array0[3:0] into a corresponding number of one-dimensional arrays according to the number of slice units allocated to each input port and the enabled state of the control signal. For example, as shown in FIG. 11, input ports Port0 and Port1 each include two slice units, and the control signal is a split control signal in the enabled state. Then, the first router subunit 234 can be configured to convert the received three-dimensional array array0[3:0] into two one-dimensional arrays array1[3:0] and array2[3:0] (the second arrays), and then transmit array1[3:0] and array2[3:0] to the first separation subunit 235. After the multiplexers 231 and 232 receive the merge control signal in the enabled state, the multiplexers 231 and 232 can send request signals to the first separation subunit 235. Then, the first separation subunit 235 can be configured to transmit the one-dimensional array array1[3:0] to the multiplexer 231 and the one-dimensional array array2[3:0] to the multiplexer 232.

In embodiments of the present disclosure, as shown in FIGS. 12 and 15, when the split control signal is in the enabled state, the multiplexer 231 is configured to generate a request signal slice_req and fetch data from the one-dimensional array array1[3:0] based on the generated request signal slice_req. The multiplexer 232 is configured to generate a request signal slice_req and fetch data from the one-dimensional array array2[3:0] based on the generated request signal slice_req. As shown in FIG. 4, the data fetch operation of the first row of image B2 includes concatenating two data blocks, chunk0 and chunk1, and the data fetch operation of the first row of image C2 includes concatenating two data blocks, chunk2 and chunk3. In the first cycle, the multiplexer 231 can be first configured to assign the request signal slice_req a value of 1, and fetch data from the one-dimensional array array1[3:0] to generate data block chunk0. The multiplexer 232 can be configured to fetch data from the one-dimensional array array2[3:0] to generate data block chunk1. Then, in the next cycle, the multiplexer 231 can be configured to assign request signal slice_req a value of 2, and fetch data from the one-dimensional array1[3:0] to generate data block chunk1. The multiplexer 232 can assign the request signal slice_req a value of 2, and fetch data from array2[3:0] to generate data block chunk3.

In the present disclosure, the terms “comprising,” “including,” or any other variants thereof are intended to cover non-exclusive inclusions, so that a process, method, article, or apparatus that includes a series of elements not only includes those elements but also includes other elements not explicitly listed, or elements inherent to such a process, method, article, or apparatus. Without further limitation, an element defined by the phrase “comprising a . . .” does not exclude the presence of additional identical elements in the process, method, article, or apparatus that includes the element.

The sequence numbers of embodiments of the present disclosure are only for descriptive purposes and do not represent the superiority of the embodiments. The features disclosed in the several method embodiments provided in the present disclosure can be arbitrarily combined, when there is no conflict, to form new method embodiments. The features disclosed in the several product embodiments provided in the present disclosure can be arbitrarily combined, when there is no conflict, to form new product embodiments. The features disclosed in the several method or apparatus embodiments provided in the present disclosure can be arbitrarily combined, when there is no conflict, to form new method or apparatus embodiments.

The above are merely embodiments of the present disclosure. The scope of the present disclosure describes only specific embodiments of the present disclosure, but the scope of protection of the present disclosure is not limited here. Those skilled in the art can easily think of variations or substitutions within the technical scope of the present disclosure, which should be within the scope of the present disclosure. Thus, the scope of the present disclosure shall be subject to the scope of the appended claims.

What is claimed is:

1. A data processing device comprising:
a control module configured to generate a control signal, the control signal being used to determine whether to perform a split processing or a merge processing on to-be-processed data; and
an encoding module connected to the control module and configured to receive the to-be-processed data and the control signal, convert the to-be-processed data into a plurality of compressed slices for caching, perform a data fetch operation on cached data on a per-cycle basis according to the control signal, and output a result of the data fetch operation.

2. The data processing device according to claim 1, wherein:
the control signal includes a merge control signal and a split control signal; and
the encoding module is configured to:
in response to the merge control signal being in an enabled state, perform the data fetch operation once each cycle, each time the data fetch operation being performed, data being fetched from the plurality of compressed slices; or
in response to the split control signal being in an enabled state, perform the data fetch operation for a plurality of times each cycle in parallel, the data fetch operation of each time including fetching data from cached data of corresponding compressed slices of the plurality of compressed slices.

3. The data processing device according to claim 2, wherein:
the encoding module includes an output unit; and
the output unit is configured to:
in response to the merge control signal being in an enabled state, select any one slice multiplexer of all slice multiplexers in the output unit to perform the data fetch operation, and output the result of the data fetch operation through an output port connected to the slice multiplexer; or
in response to the split control signal being in an enabled state, select a plurality of slice multiplexers from all the slice multiplexers of the output unit, perform the data fetch operation in parallel, and output the result of the data fetch operation in parallel through the plurality of output ports connected to the plurality of slice multiplexers.

4. The data processing device according to claim 3, wherein:
each slice multiplexer is connected to the control module and is configured to receive the control signal, generate a request signal, adjust an assignment value of the request signal based on the control signal, and perform the data fetch operation according to a block size based on the adjusted assignment value of the request signal; and
the assignment value of the request signal is used to select the compressed slice corresponding to the data fetch operation of each time from the plurality of compressed slices, and a data capacity of the block size is smaller than a data capacity of the compressed slice.

5. The data processing device according to claim 3, wherein:
the output unit further includes a first router subunit; and
the first router subunit is connected to the control module and all of the slice multiplexers and is configured to:
in response to the merge control signal being in an enabled state, transmit the cached data of the plurality of compressed slices to any one slice multiplexer selected by the merge control signal; or
in response to the split control signal being in the enabled state, transmit the cached data of the plurality of compressed slices to the plurality of slice multiplexers selected by the split control signal.

6. The data processing device according to claim 3, wherein:
the encoding module further includes an input unit; and
the input unit is configured to:
in response to the merge control signal being in the enabled state, select a plurality of input ports from all input ports of the input unit to receive a plurality of pieces of sub-data of the to-be-processed data, respectively, and decompose the corresponding received sub-data via slice units connected to each input port; or
in response to the split control signal being in the enabled state, select any one input port from all the input ports of the input unit to receive the to-be-processed data and select the plurality of slice units from all the slice units of the input unit to decompose the to-be-processed data.

7. The data processing device according to claim 6, wherein:
the input unit includes a second router subunit; and
the second router subunit is connected to the control module and all the input ports and is configured to:
in response to the merge control signal being in the enabled state, transmit the sub-data received at each input port to the slice units connected to the input port; or
in response to the split control signal being in the enabled state, transmit the to-be-processed data to the plurality of slice units selected by the split control signal.

8. The data processing device according to claim 6, wherein:
the encoding module further includes an encoding compression unit; and
the encoding compression unit is connected to the input unit and the output unit and is configured to convert the data received by each slice unit into a corresponding compressed slice, and cache data of the plurality of compressed slices through a plurality of bitrate buffer units in the encoding compression unit.

9. The data processing device according to claim 2, wherein:
the control module includes a first register and a second register;
the first register is configured to generate the merge control signal in the enabled state in response to performing merge processing on the to-be-processed data; and
the second register is configured to generate the split control signal in the enabled state in response to performing split processing on the to-be-processed data.

10. A data processing method comprising:
obtaining to-be-processed data and a control signal, the control signal being used to determine whether to perform split processing or merge processing on the to-be-processed data, and the control signal including a merge control signal and a split control signal;
converting the to-be-processed data into a plurality of compressed slices for caching; and
performing a data fetch operation on cached data on a per-cycle basis based on the control signal, and outputting a result of the data fetch operation;
wherein:
in response to the merge control signal being in an enabled state, the data fetch operation is performed once per cycle, and data is fetched from cached data of the plurality of compressed slices each time the data fetch operation is performed; or
in response to the split control signal being in an enabled state, the data fetch operation is performed multiple times in parallel per cycle, and data is fetched from cached data of a corresponding portion of compressed slices of the plurality of compressed slices each time the data fetch operation is performed.

11. The data processing method according to claim 10, wherein performing the data fetch operations on the cached data on the per-cycle basis based on the control signal includes:
converting data of the plurality of compressed slices into a first array;
in response to the merge control signal, converting the first array into a second array;
generating a plurality of request signals, and adjusting assignment values of the plurality of request signals in response to the merge control signal, wherein, each digit of the assignment value of a request signal of the plurality of request signals after adjustment is used to indicate fetching data from the second array, different assignment values of the request signal represent a plurality of pieces of data in a same row in the second array, respectively, and each digit of the assignment value of remaining request signals is used to indicate of not fetching data; and
in response to the merge control signal and the plurality of adjusted request signals, the data fetch operation is performed on the second array.

12. The data processing method according to claim 10, wherein performing the data fetch operation on the cached data on the per-cycle basis based on the control signal includes:
converting data of the plurality of compressed slices into a first array;
in response to the split control signal, converting the first array into a plurality of second arrays;
generating a plurality of request signals, and adjusting assignment values of the plurality of request signals in response to the split control signal, wherein, each digit of the assignment value of each adjusted request signal is used to indicate fetching data from a corresponding second array, and different assignment values of each request signal represent a plurality of pieces of data in a same row in the second array, respectively; and
in response to the split control signal and the plurality of adjusted request signals, the data fetch operation is performed on the second array.

13. A computer-readable storage medium storing a program that, when executed by one or more processors, causes the one or more processors to:
generate a control signal, the control signal being used to determine whether to perform a split processing or a merge processing on to-be-processed data;
receive the to-be-processed data and the control signal;
convert the to-be-processed data into a plurality of compressed slices for caching;
perform a data fetch operation on cached data on a per-cycle basis according to the control signal; and
output a result of the data fetch operation.

14. The computer-readable storage medium according to claim 13, wherein the one or more processors are configured to:
in response to the merge control signal being in an enabled state, perform the data fetch operation once each cycle, each time the data fetch operation being performed, data being fetched from the plurality of compressed slices; or
in response to the split control signal being in an enabled state, perform the data fetch operation for a plurality of times each cycle in parallel, the data fetch operation of each time including fetching data from cached data of corresponding compressed slices of the plurality of compressed slices.

15. The computer-readable storage medium according to claim 14, wherein the one or more processors are further configured to:
in response to the merge control signal being in an enabled state, select any one slice multiplexer of all slice multiplexers in the output unit to perform the data fetch operation, and output the result of the data fetch operation through an output port connected to the slice multiplexer; or
in response to the split control signal being in an enabled state, select a plurality of slice multiplexers from all the slice multiplexers of the output unit, perform the data fetch operation in parallel, and output the result of the data fetch operation in parallel through the plurality of output ports connected to the plurality of slice multiplexers.

16. The computer-readable storage medium according to claim 15, wherein the one or more processors are further configured to:
receive the control signal, generate a request signal, adjust an assignment value of the request signal based on the control signal, and perform the data fetch operation according to block size based on the adjusted assignment value of the request signal;
wherein the assignment value of the request signal is used to select the compressed slice corresponding to the data fetch operation of each time from the plurality of compressed slices, and a data capacity of the block size is smaller than a data capacity of the compressed slice.

17. The computer-readable storage medium according to claim 15, wherein the one or more processors are further configured to:
in response to the merge control signal being in an enabled state, transmit the cached data of the plurality of compressed slices to any one slice multiplexer selected by the merge control signal; or
in response to the split control signal being in the enabled state, transmit the cached data of the plurality of compressed slices to the plurality of slice multiplexers selected by the split control signal.

18. The computer-readable storage medium according to claim 15, wherein the one or more processors are further configured to:
in response to the merge control signal being in the enabled state, select a plurality of input ports from all input ports of the input unit to receive a plurality of pieces of sub-data of the to-be-processed data, respectively, and decompose the corresponding received sub-data via slice units connected to each input port; or
in response to the split control signal being in the enabled state, select any one input port of all the input ports of the input unit to receive the to-be-processed data and select the plurality of slice units from all the slice units of the input unit to decompose the to-be-processed data.

19. The computer-readable storage medium according to claim 18, wherein the one or more processors are further configured to:
in response to the merge control signal being in the enabled state, transmit the sub-data received at each input port to the slice units connected to the input port; or
in response to the split control signal being in the enabled state, transmit the to-be-processed data to the plurality of slice units selected by the split control signal.

20. The computer-readable storage medium according to claim 18, wherein the one or more processors are further configured to:
convert the data received by each slice unit into a corresponding compressed slice, and cache data of the plurality of compressed slices through a plurality of bitrate buffer units in the encoding compression unit.
